(19) United States
(12) Patent Application Publication
(10) Pub. No.: US 2005/0114261 A1
(43) Pub. Date: May 26, 2005

(54) Payment system for using a wireless network system and its method

(75) Inventor: Wen-Chih Lin, SanChung City (TW)

Correspondence Address: TROXELL LAW OFFICE PLLC, Suite 1404, 5205 Leesburg Pike, Falls Church, VA, 22041, US

(73) Assignee: Chuang Guan Technology Co., Ltd.

(21) Appl. No.: 10/717,488

(22) Filed: Nov. 21, 2003

(51) Int. Cl. G06F 17/60

(52) U.S. Cl. 705/40

(57) ABSTRACT

The present invention relates to the payment system for using the wireless network and its method, the payment system comprises a wireless device with a SIM card; a wireless AP (access point), an ADSL (Asymmetric Digital Subscriber Line), a Web-SIM gateway, a web authentication server, an accounting authorization server, a HLR (Home Location Register) and a PSTN (Public Switched Telephone Network). When a user employs the wireless network to connect to Internet via the wireless AP, an ADSL, a Web-SIM gateway and a web authentication server, the user must be identified by a payment and identity system constituting of the accounting authorization server, the HLR and the PSTN to connect to Internet and trade in Internet

### FIELD OF THE INVENTION

The present invention relates to a payment system for using a wireless network system and its method, and more particularly it indicates a network interface equipment with an unique payment and identity system unit issued to the users with network connecting to the network in order to connect to internet and trade in internet.

### BACKGROUND OF THE INVENTION

Presently, most of the wireless networks ISPs provide private service, and both of the service area and the service charge are different. The wireless network can be separate into two groups roughly, one group is that users rent unique hotspot interface cards of wireless network hotspot from the wireless network ISP around the users connecting to Internet or networks; another group is that users connect to the hotspot of the wireless network ISP with their own wireless network interface card then input their accounts and passwords provided by the wireless network ISP.

However, the differences among service areas, provided services and service charges are caused by that each ISP is individual. Users must, be used for different services when changing to different service area. At the moment, the service charge can be separate into two groups, one group is that users purchase the coupons from local ISPs in advance, another group is that users pay by cash. Hence, it would be trouble to users by the payment method as described above.

To cite an instance, a user engages in network shopping by way of two different wireless ISPs (cybercafe), wherein the connection fees for the two ISPs are different, and furthermore, the network shopping may generate another credit card bill, so, talking about the aspect of only one wireless ISPs, the user should pay twice for the shopping, one for wireless connection, another for monthly credit card account. On the other hand, while the user shopping via two wireless ISPs, a complicate situation for payment is then happened due to different wireless connection charges and the paying method as aforesaid. Reflection from above is an important issue, how to purify the payment and the service charge, to consumers.

Please refer to the attached FIG. 1, which is a sketch of a wireless system in prior arts. The prior art comprises a wireless device 11, a wireless access point 12, an ADSL (Asymmetric Digital Subscriber Line) 13, a Web Authentication Server 14 and an internet 15. The wireless device 11 connects with the network provided by the wireless network ISP through the wireless access point 12, wherein, the wireless device 11 can be any kind of the portable device with wireless network connection function, for example, a PDA (Personal Digital Assistant), an IP phone (Internet protocol phone), a Notebook, etc., then connects to the Web Authentication Server 14 and is identified via the ADSL 13, the ISP can identify the unique wireless network card of the wireless network hotspot or the account and the password. Such that, the user freely connects to the Internet 15.

With such inconvenience, the patent in application with application No. 9113094 in Taiwan focuses on the method to solve connecting models and settings among ISPs. The solution can be described as below roughly, it is that to provide a wireless network interface card with a SIM card connecting device, and insert a SIM card into the SIM card connecting device to connect to a wireless network. Simultaneously, transmitting a SSID (Service Set Identifier) and a password to a server for identification to let a user freely browse among ISPs.

The patent in application with application No. 92102098 in Taiwan is to provide a wireless network card with a SIM card connecting device, then insert a SIM card into the SIM card connecting device and connect to a wireless network via the wireless network card. Simultaneously, transmitting a SSID (Service Set Identifier) and a password to a server for identification to let a user freely browse among ISPs.

However, the prior arts as aforesaid concentrate upon the issue of a client browsing among a plurality of ISPs, which means how to solve the problem of an upstream of consumers, otherwise, the other issue of disorder of charging and paying may not be discussed, which means the problem of a downstream of consumers does not be covered so far. Again, how to purify the payment and the service charge becomes an important issue and will be disclosed as following.

### SUMMARY OF THE INVENTION

The present invention relates to a payment system for using a wireless network system and its method, whose first objective is to improve the present confuse payment system, and provide a unique payment system and method regarding clients browsing among different ISPs.

The present invention relates to the payment system for using the wireless network and its method, whose second objective is to improve the present identification system, and provide a unique charging method without any change among different ISPs.

The present invention relates to the payment system for using the wireless network and its method, the payment system comprises a wireless device with a SIM card; a wireless AP (access point), an ADSL (Asymmetric Digital Subscriber Line), a Web-SIM gateway, a web authentication server, an accounting authorization server, a HLR (Home Location Register) and a PSTN (Public Switched Telephone Network). When a user employs the wireless network to connect to Internet via the wireless AP, an ADSL, a Web-SIM gateway and a web authentication server, the user must be identified by a payment and identity system constituting of the accounting authorization server, the HLR and the PSTN to connect to Internet and trade in Internet Due to the SIM card being issued by the payment and identity system. The payment of the present invention comprises: a client being identified by the payment and identity system while connecting to the payment and identity; judging the SIM card from the client, if yes, going to a process of authorization, if no, the client being not a member of the payment and identity system.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawing, which is incorporated in and constitutes a part of this specification, illustrates several embodiments of the invention and together with the description, serves to explain the principles of the invention.

### BEIEF DESCRIPTION OF THE DRAWINGS

FIG. 1 is a sketch of a wireless system in prior arts;

FIG. 2 is a sketch of a wireless network system of the present invention; and

FIG. 3 is a flowchart of the identification of the Web-SIM gateway of the present invention.

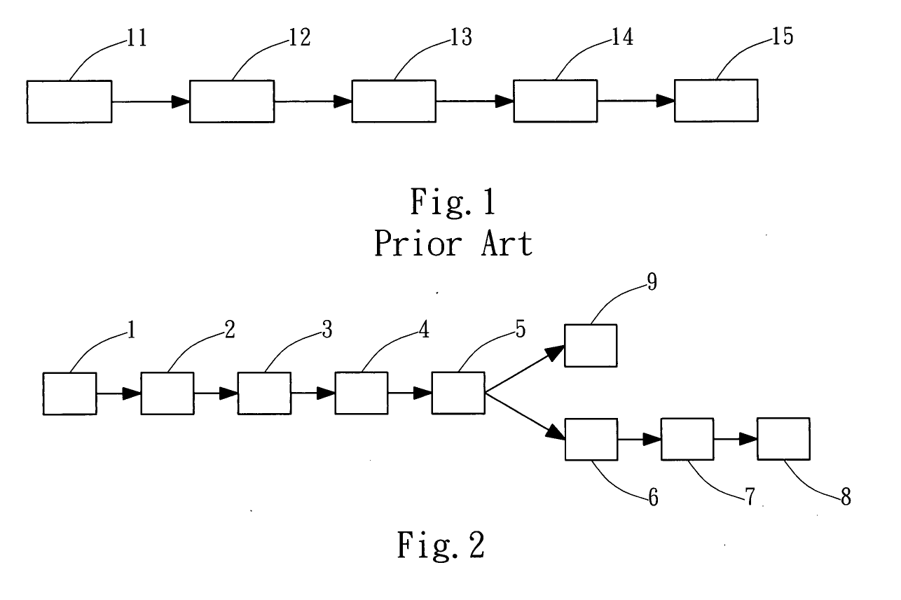

### DESCRIPTION OF THE EMBODIMENTS

Please refer to FIG. 2, which is a sketch of a wireless network system of the present invention. The system of the present invention comprises a wireless network equipment, a wireless device 1; a wireless network system including a wireless AP (Access Point) 2 and a fix network, an ADSL 3; a network service system including a Web-SIM gateway 4 and a web authentication server 5; a payment and identity system including a accounting authorization server 6, a HLR 7 and a PSTN 8, wherein the wireless device 1 having a SIM Card issued by the payment and identity system. When wireless device 1 being close to one of hotspots of the wireless AP 2 of the wireless network, wireless device 1 sends a SSID and a user's password to the hotspot for identification so as to that allowing the user roaming among different ISPs. Wherein, wireless device 1 can be any kind of portable equipment with wireless network function, for example, PDA, IP phone, notebook, etc.

When the wireless device 1 connects with the wireless AP 2, wireless device 1 requests for identity via EAP-SIM (Extensible Authentication Protocol-Subscriber Identity Module) method. After the identification being recognized, wireless device 1 is capable of accessing the hotspot to browse in Internet 9, or connecting to PSTN 8 via HLR 7 of the payment and identity system. Processes of the identification will be discussed in detail later.

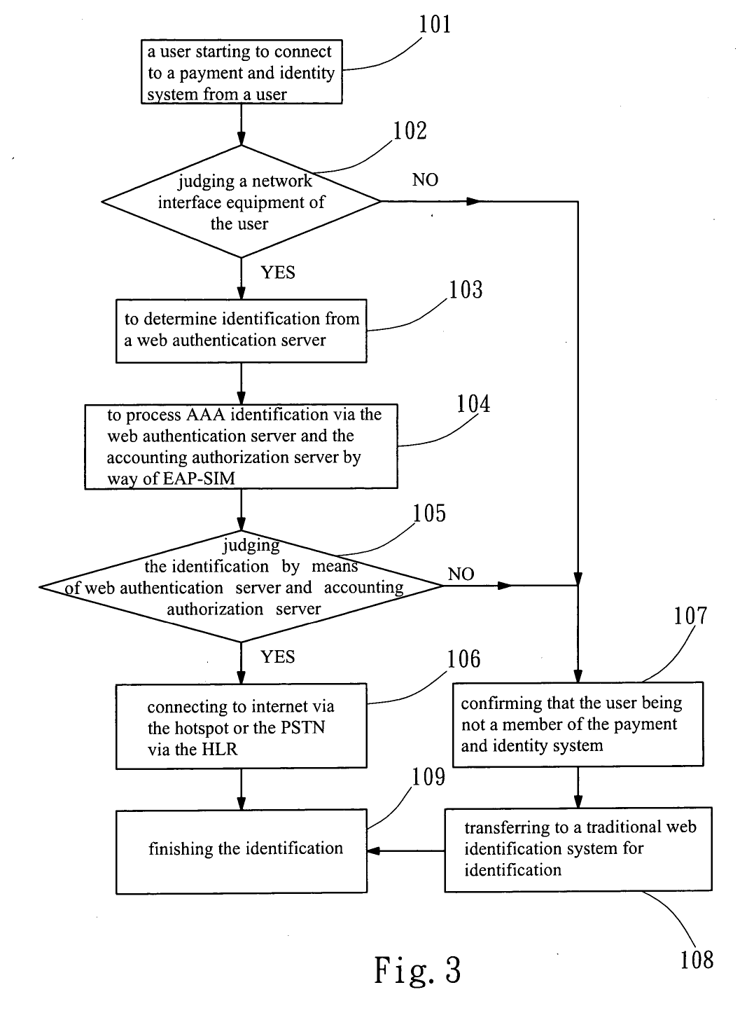

Please refer to FIG. 3, which is a flowchart of the identification of the Web-SIM gateway of the present invention. The steps of the flowchart are: step 101, a user starting to connect to a payment and identity system from a user; step 102, judging a network interface equipment of the user, a SIM card, if not, going to step 107, if yes, going to next step; step 103, to determine identification from a web authentication server; step 104, to process AAA identification via the web authentication server 5 and the accounting authorization server 6 by way of EAP-SIM; step 105, judging the identification by means of web authentication server 5 and accounting authorization server 6, if yes, going to next step, if not, going to step 107; step 106, connecting to Internet via the hotspot or the PSTN 8 via the HLR 7, then going to step 109; step 107, confirming that the user being not a member of the payment and identity system; step 108, transferring to a traditional web identification system for identification; step 109, finishing the identification. Connection fee is summed up by wireless network ISP and charged into the payment and identity system; on the other hand, an amount of shopping in Internet is given to the payment and identity system by web store. At last, the payment and identity system sends the bill to the user automatically and periodically. After the bill being paid, the payment and identity system, the wireless network ISP and the web store share the service charge.

For example, a user purchases same merchandise via the method of the present invention from both wireless network ISPs A and B, wherein the service charges of the wireless network ISPs A and B are different, and other additional charge may then be generated while shopping on Internet, but the user is only responsible for the payment and identity system as well.

The present invention can be coexisted with the existing wireless network structures and smoother for both sides during transition stage. The method of the present invention is convenient to users because the different service charges among the plural wireless network ISPs being neglected. Hence, users or clients only focus on the standard service charge issued by the payment and identity system.

It is to be understood that while the invention has been described above in conjunction with preferred specific embodiments, the description and examples are intended to illustrate and not limit the scope of the invention, which is defined by the scope of the appended claims.

1. A payment system for using a wireless network system comprising:
a wireless network equipment having a network interface equipment;
a wireless network system;
a network service system, the wireless network equipment being connected to the network service system via the network interface equipment and the wireless network system;
a payment and identity system connecting to a network via the wireless network system and the network service system, the payment and identity system being a role of identification and issuing the network interface equipment.

2. The payment system for using the wireless network system as described in claim 1, wherein the wireless network equipment is a PDA.

3. The payment system for using the wireless network system as described in claim 1, wherein the wireless device is an IP Phone.

4. The payment system for using the wireless network system as described in claim 1, wherein the wireless device is a notebook.

5. The payment system for using the wireless network system as described in claim 1, wherein the network interface equipment is a SIM Card.

6. The payment system for using the wireless network system as described in claim 1, wherein the wireless network device comprising a wireless AP and a fix network.

7. The payment system for using the wireless network system as described in claim 6, wherein the fix network is an ADSL.

8. The payment system for using the wireless network system as described in claim 1, wherein the network service system comprising a Web-SIM gateway and a web authentication server.

9. The payment system for using the wireless network system as described in claim 1, wherein the payment and identity system comprising a HLR, a PSTN and an accounting authorization server.

10. A payment method for using a wireless network system comprising:
(1) starting to connect to a payment and identity system from a user;
(2) judging a network interface equipment of the user, if yes, going to next step;
(3) to be identified, and going to next step if pass;
(4) connecting to the payment and identity system and going to step (6);
(5) assuring the user being not a member of the payment and identity system, going to step (6);
(6) finishing the method.

11. The payment method for using the wireless network system as described in claim 10, wherein the network interface equipment of step (2) is a SIM Card.

12. The payment method for using the wireless network system as described in claim 10, wherein if step (2) judged as fail, then going to step (5).

13. The payment method for using the wireless network system as described in claim 10, wherein step (3) further comprising:
(3A). to determine identification form a web authentication server;
(3B). to process the identification via the web authentication server and an accounting authorization server by way of EAP-SIM.

14. The payment method for using the wireless network system as described in claim 10, wherein if step (3) judged as fail, then going to step (5).

15. The payment method for using the wireless network system as described in claim 10, wherein the payment and identity in step (4) further comprising a HLR, a PSTN and an accounting authorization server.

16. The payment method for using the wireless network system as described in claim 10, wherein, after assuring the user being not a member of the payment and identity system, then transferring to a traditional web identification system for identification.
